(19) United States
(12) Patent Application Publication
(10) Pub. No.: US 2026/0168741 A1
(43) Pub. Date: Jun. 18, 2026

(54) TUBULAR ELEMENT FOR A HEAT EXCHANGER

(71) Applicant: VALEO SYSTEMES THERMIQUES, La Verriere (FR)

(72) Inventors: Dominik SPORNA, San Mateo, CA (US); Juan-Carlos BATISTA, La Verriere (FR); Christophe HERAULT, La Verriere (FR); Eric GOYET, La Verriere (FR); Etienne CHARDIN, La Verriere (FR); Laurent PASQUET, La Verriere (FR); Donald Henry BOYD, IV, Auburn Hills, MI (US); Matthew SZYMCZAK, Auburn Hills, MI (US); William DODSON, Reno, NV (US); Matthew C. BLOSS, Reno, NV (US)

(73) Assignee: VALEO SYSTEMES THERMIQUES, La Verriere (FR)

(21) Appl. No.: 18/982,699

(22) Filed: Dec. 16, 2024

(51) Int. Cl. F28F 1/02; F28F 1/04; F28F 9/16

(52) U.S. Cl. CPC F28F 1/022; F28F 1/04; F28F 9/16

(57) ABSTRACT

A tubular element for a heat exchanger, including: a primary tank with an inlet chamber and an outlet chamber for a heat exchange fluid, a secondary tank, a tube with inlet channels and outlet channels, configured so as to provide U-flow for the fluid within the tubular element. The primary tank includes a dividing wall between the inlet and outlet chambers. The tube includes a first separation wall and a second separation wall with a separation space there-between. The dividing wall is in contact with the first and second separation walls. The inlet channels include a first inlet channel limited by the first separation wall and an inlet channel wall. The outlet channels include a first outlet channel limited by the second separation wall and an outlet channel wall. The separation space includes a central arcuate structure adjacent the dividing wall.

### TECHNICAL FIELD

The present invention pertains to a tubular element designed for use in a heat exchanger, particularly for regulating the temperature of an electric device, such as a battery in a vehicular system.

### BACKGROUND OF THE INVENTION

A critical component of electric vehicle technology is the battery pack, which serves as the primary energy storage system. Among various battery formats, cylindrical, e.g. lithium-ion, cells are widely used due to their high energy density, structural stability, and efficient packing configuration.

Thermal management of these battery packs is essential to ensure optimal performance, safety, and longevity. During operation, battery cells generate significant heat, particularly during high discharge rates or rapid charging. Conversely, in cold conditions, batteries may require heating or conditioning to maintain efficient and prevent capacity loss due to low temperatures.

Effective cooling is required to prevent overheating, which can lead to reduced efficiency, accelerated degradation, or even thermal runway in extreme cases, while active heating systems are necessary to ensure consistent performance in suboptimal thermal environments.

Heat exchangers are commonly employed in battery systems to manage temperature. These systems often rely on tubular elements to circulate a heat exchange fluid for heat dissipation. The design of these tubular elements is crucial to achieving uniform and efficient cooling across the densely packed cylindrical cells in a battery module.

Undulated tubes have emerged as an effective solution for improving heat transfer in such applications. The wavy geometry promotes turbulence in the heat exchange fluid flow, increasing the efficiency of heat exchange between the surface and the fluid. Additionally, wavy tubes are adaptable to the complex geometries of battery packs, ensuring consistent cooling across all cells and reducing the risk of localized hotspots.

There remains a need for a tubular element specifically optimized for use in heat exchangers for cylindrical battery packs in electric vehicles. Such a solution should address the dual objectives of enhancing heat dissipation and conforming to the compact and intricate design requirements of modern battery systems. This invention aims to fulfill these needs.

### SUMMARY OF THE INVENTION

An object of the invention is a tubular element for a heat exchanger, comprising: a primary tank with an inlet chamber and an outlet chamber for a heat exchange fluid, a secondary tank, a tube extending between the primary tank and the secondary tank, with a set of inlet channels and a set of outlet channels, configured so as to provide U-flow for the fluid within the tubular element, wherein the primary tank includes a dividing wall between the inlet chamber and the outlet chamber, wherein the tube includes a first separation wall and a second separation wall with a separation space between the first separation wall and the second separation wall, the first separation wall and the second separation wall being configured to block fluid flow between the set of inlet channels and the set of outlet channels within the tube, wherein the dividing wall is in contact with the first separation wall and the second separation wall, wherein the set of inlet channels includes a first inlet channel limited by the first separation wall and an inlet channel wall, and wherein the set of outlet channels includes a first outlet channel limited by the second separation wall and an outlet channel wall, wherein the separation space includes a central arcuate structure adjacent the dividing wall.

In one example, the central arcuate structure extends through the whole tube between the primary tank and the secondary tank.

In one example, the first inlet channel includes an inlet arcuate structure at the first separation wall, while the first outlet channel includes an outlet arcuate structure at the second separation wall.

In one example, the inlet arcuate structure and the outlet arcuate structure extend through the whole tube between the primary tank and the secondary tank.

In one example, the tube includes a top wall and a bottom wall opposite the top wall, with the set of inlet channels and the set of outlet channels being arranged between the top wall and the bottom wall, wherein the inlet arcuate structure and the outlet arcuate structure extend over the top wall and the bottom wall.

In one example, the first inlet channel includes an inlet flat section at the inlet channel wall, while the first outlet channel includes an outlet flat section at the outlet channel wall.

In one example, the central arcuate structure forms a circular shape in cross-section of the separation space.

In one example, the tube includes a top wall and a bottom wall opposite the top wall, with the set of inlet channels and the set of outlet channels being arranged between the top wall and the bottom wall, wherein the separation space has a height smaller than the height of the first inlet channel or the first outlet channel when measured along the inlet channel wall or outlet channel wall, respectively.

In one example, the separation space is formed of two separation space portions arranged next to each other with a third separation wall placed between them.

In one example, the tube includes a top wall and a bottom wall opposite the top wall, with the set of inlet channels and the set of outlet channels being arranged between the top wall and the bottom wall, wherein the first separation wall and the second separation wall extend between the top wall and the bottom wall.

In one example, the tube includes a top wall and a bottom wall opposite the top wall, with the set of inlet channels and the set of outlet channels being arranged between the top wall and the bottom wall, wherein the inlet channel wall and the outlet channel wall extend between the top wall and the bottom wall.

In one example, the set of inlet channels includes a plurality of second inlet channels of a rectangular shape in cross-section, arranged in series next to each other, while the set of outlet channels includes a plurality of second outlet channels of a rectangular shape in cross-section, arranged in series next to each other.

In one example, the tube extends along a meandering path between the primary tank and the secondary tank.

In one example, the primary tank is formed from two shaped portions connected to each other.

In one example, the two shaped portions are connected to each other by crimping tabs present on at least one of the two shaped portions.

In one example, each of the two shaped portions includes a dividing wall component extending towards the other of the two shaped portions so that the dividing wall components are connected to each other and together they form the dividing wall.

In one example, the dividing wall is in contact with the central arcuate structure.

In one example, the dividing wall is in contact with the inlet arcuate structure and the outlet arcuate structure.

In one example, the dividing wall is brazed with the inlet arcuate structure and the outlet arcuate structure.

Another object of the invention is a tube for a tubular element of a heat exchanger, comprising: a set of inlet channels and a set of outlet channels, and a first separation wall and a second separation wall with a separation space between the first separation wall and the second separation wall, the first separation wall and the second separation wall being configured to block fluid flow between the set of inlet channels and the set of outlet channels within the tube; wherein the set of inlet channels includes a first inlet channel limited by the first separation wall and an inlet channel wall, and wherein the set of outlet channels includes a first outlet channel limited by the second separation wall and an outlet channel wall, wherein the set of inlet channels includes a plurality of second inlet channels of a rectangular shape in cross-section, arranged in series next to each other, while the set of outlet channels includes a plurality of second outlet channels of a rectangular shape in cross-section, arranged in series next to each other, wherein the separation space includes a central arcuate structure, wherein the first inlet channel includes an inlet flat section at the inlet channel wall, while the first outlet channel includes an outlet flat section at the outlet channel wall, wherein the first inlet channel includes an inlet arcuate structure at the first separation wall, while the first outlet channel includes an outlet arcuate structure at the second separation wall.

### BRIEF DESCRIPTION OF DRAWINGS

The present invention will be described in greater detail below with reference to the drawings. In the drawings:

FIG. 1 shows a tubular element in a perspective view;

FIG. 2 shows the primary tank of the tubular element in a perspective view;

FIG. 3 shows the secondary tank of the tubular element in a perspective view;

FIG. 4 shows a partial perspective view of a primary tank with one of the shaped portions removed;

FIG. 5 shows a closer view of the primary tank of FIG. 4;

FIG. 6 shows schematically a view of an example of a tube of the tubular element;

FIG. 7 shows schematically a view of another example of a tube of the tubular element; and

FIG. 8 shows schematically a view of an example of a tube of the tubular element.

### DETAILED DESCRIPTION OF THE INVENTION

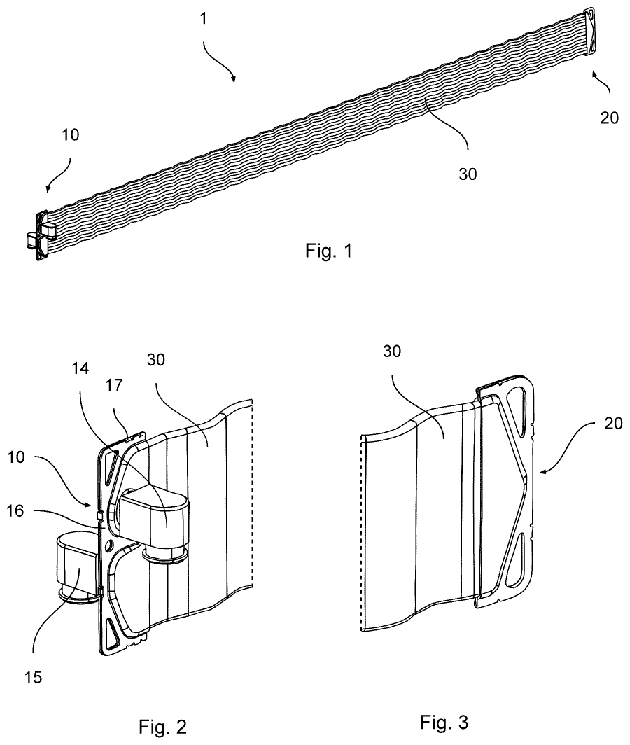

FIG. 1 shows a tubular element 1 for a heat exchanger in a perspective view, with FIG. 2 and FIG. 3 showing respectively a primary tank 10 and a secondary tank 20 of the tubular element 1 in closer views. The tubular element 1 comprises a primary tank 10 and a secondary tank 20. A tube 30 extends between the primary tank 10 and the secondary tank 20. The primary tank 10, the secondary tank 20 and the tube 30 are configured so as to provide U-flow for the fluid within the tubular element 1. The primary tank 10 can be a distribution tank. The secondary tank 20 can be a return tank. The tube 30 can be a flat, wavy tube, to maximize the surface area in contact with the battery cell. The U-flow arrangement refers to the coolant flow pattern where fluid enters the tube 30, travels in one direction to the end, and then reverses its path in the opposite direction within the same tube. This creates a “U”-shaped flow path within the flat tube, which is designed to optimize heat exchange performance and flow uniformity.

The primary tank 10 includes an inlet chamber 11 with an inlet connector 14, as well as an outlet chamber 12 with an outlet connector 15. The inlet chamber 11 is separated from the outlet chamber 12 within the primary tank 10. The heat exchange fluid enters the tube 30 and flows along the first leg of the U-path, absorbing heat from the battery cell through the flat surface or giving the heat away to the cell.

The secondary tank 20 ensures flow reversal, in a sense that the heat exchange fluid is redirected to flow back along the second leg of the U-path, further enhancing heat exchange. The heat exchange fluid exits the tube 30 after completing the U-path.

The tube 30 extends along a meandering path between the primary tank 10 and the secondary tank 20.

The tube 30 can be extruded. The tube 30 can be of aluminum.

The primary tank 10 can be formed from two shaped portions 16 connected to each other. The two shaped portions 16 can be connected to each other by crimping tabs 17 present on at least one of the two shaped portions 16.

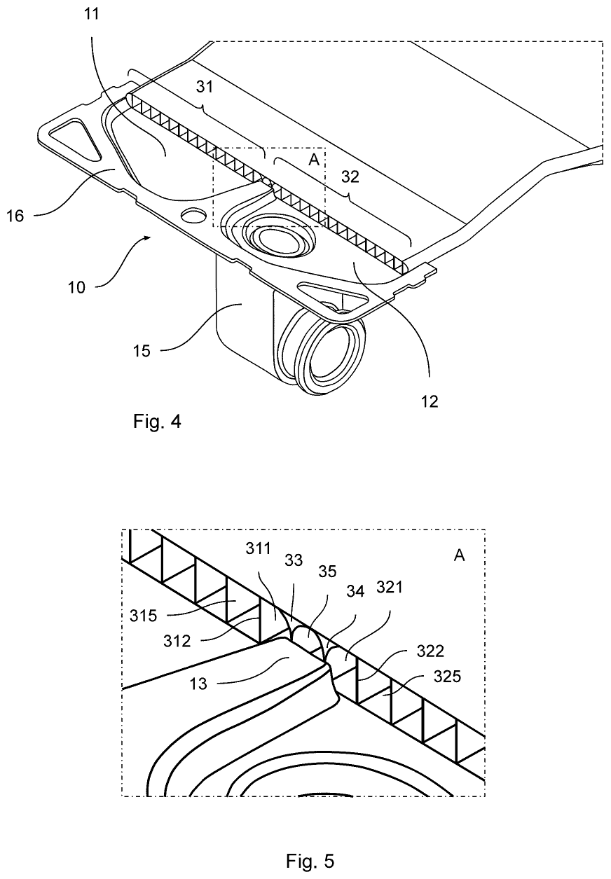

FIG. 4 shows a partial perspective view of a primary tank with one of the shaped portions removed, while FIG. 5 shows a closer view of the primary tank of FIG. 4.

The tube 30 includes a set of inlet channels 31 and a set of outlet channels 32. The set of inlet channels 31 leads the fluid from the primary tank 10 to the secondary tank 20. The set of outlet channels 32 leads the fluid from the secondary tank 20 to the primary tank 10. In other words, both the set of inlet channels 31 and the set of outlet channels 32 terminate in the primary tank 10 and the secondary tank 20.

The primary tank 10 includes a dividing wall 13 between the inlet chamber 11 and the outlet chamber 12. The dividing wall 13 separates the fluid within the inlet chamber 11 from the fluid in the outlet chamber 12.

Each of the two shaped portions 16 can include a dividing wall component 13 extending towards the other of the two shaped portions 16 so that the dividing wall components 13 can be connected to each other and together they form the dividing wall 13.

The dividing wall 13 can be in contact with the first separation wall 33 and the second separation wall 34.

The tube 30 can include a first separation wall 33 and a second separation wall 34 with a separation space 35 between the first separation wall 33 and the second separation wall 34. The first separation wall 33 and the second separation wall 34 can be configured to block fluid flow between the set of inlet channels 31 and the set of outlet channels 32 within the tube 30.

In general, when brazing aluminum, the filler material travels along the elements primarily through capillary action, driven by precise heating and preparation. As the aluminum components are heated to the brazing temperature (typically between 570 degree Celsius and 620 degree Celsius), the brazing filler, often an aluminum-silicon alloy, melts at a lower temperature then the base material. The molten filler flows between the tightly fitted aluminum components, drawn by capillary action, while surface tension helps it distribute uniformly. As the assembly cools, the filler material solidifies, creating a strong, durable metallic bond. Proper joint preparation is essential for efficient and uniform brazing.

Preferably, the separation space 35 includes a central arcuate structure 36 adjacent the dividing wall 13. The purpose of the central arcuate structure 36 is to draw the filler material along its shape to provide enough material to connect adjacent elements, in particular the first separation wall 33, second separation wall 34, the top wall 37, the bottom wall 38 and the dividing wall 13. Thanks to the central arcuate structure 36 the material can be evenly distributed, through capillary action, between those elements, which leads to a robust and sealed connection. Such connection is essential if the fluid is to be prevented from leaking between the inlet chamber 11 and the outlet chamber 12. It allows also accommodating the dividing wall 13, which thanks to presence of a separation space 35 does not have to be minimized and hence can simplify the manufacturing considerations, e.g. stamping process for the primary tank 10.

The central arcuate structure 36 can extend over the whole length of the tube 30 in order to accommodate standard extrusion process. The central arcuate structure 36 can be specifically shaped fragment of the tube 30, present in and defining the separation space 35. The central arcuate structure 36 can be an integral part of the tube material with a shape facing the separation space 35 providing arcuate characteristics.

The dividing wall 13 can be in contact with the central arcuate structure 36.

The set of inlet channels 31 can include a first inlet channel 311 limited by the first separation wall 33 and an inlet channel wall 312. The set of outlet channels 32 can include a first outlet channel 321 limited by the second separation wall 34 and an outlet channel wall 322. The inlet channel wall 311 and the outlet channel wall 322 are not in contact with the dividing wall 13.

The set of inlet channels 31 can include a plurality of second inlet channels 315 of a rectangular shape in cross-section, arranged in series next to each other. The set of outlet channels 32 can include a plurality of second outlet channels 325 of a rectangular shape in cross-section, arranged in series next to each other. In other words, channels of the sets 31, 32 feature a cross-sectional geometry that is substantially rectangular. The rectangular cross-sectional shape can be defined by parallel opposing walls interconnected by perpendicular side walls, forming a continuous enclosed pathway for the flow of fluid. This configuration ensures uniform dimensions along the length of each channel, promoting consistent fluid dynamics and heat transfer characteristics. The channels can be designed to be evenly spaced, maintaining a uniform interval between adjacent channels to optimize structural integrity and thermal performance within the system. The term “substantially rectangular” is used in a sense that inner corners of the channels will at some level be slightly rounded due to manufacturing constraints.

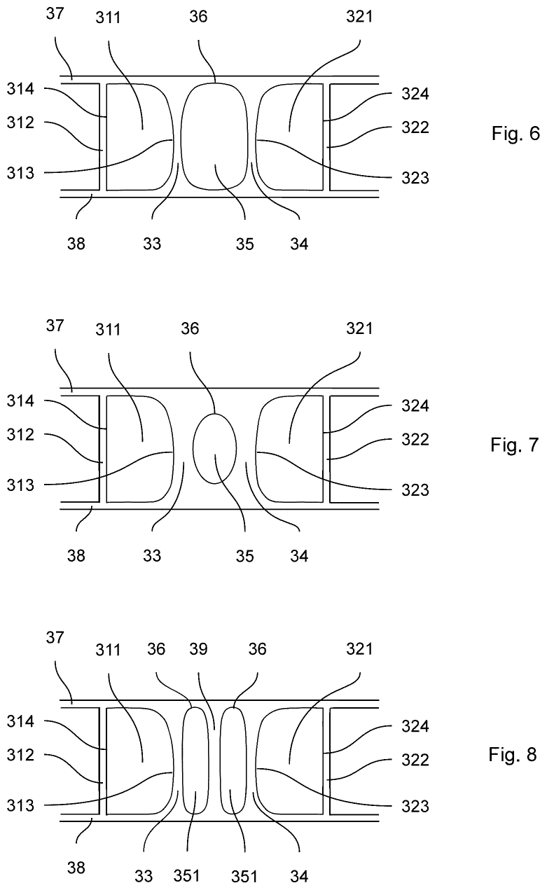

FIG. 6 shows schematically a view of an example of a tube 30 of the tubular element 1. The tube 30 includes a top wall 37 and a bottom wall 38 opposite the top wall 37. The set of inlet channels 31 and the set of outlet channels 32 can be arranged between the top wall 37 and the bottom wall 38.

The first inlet channel 311 can include an inlet flat section 314 at the inlet channel wall 312. The first outlet channel 321 can include an outlet flat section 324 at the outlet channel wall 322.

The first inlet channel 311 can include an inlet arcuate structure 313 at the first separation wall 33. The first outlet channel 321 can include an outlet arcuate structure 323 at the second separation wall 34. The function of the inlet arcuate structure 313 and the outlet arcuate structure 323 is similar as that of the central arcuate structure 36. The purpose is to assist the capillary action of the filler material so that the material is uniformly distributed during brazing and a seal is created between the crucial regions of the tubular element 1.

The inlet arcuate structure 313 and the outlet arcuate structure 323 can extend through the whole tube 30 between the primary tank 10 and the secondary tank 20. The inlet arcuate structure 313 and the outlet arcuate structure 323 can extend over the top wall 37 and the bottom wall 38.

In general, the inlet arcuate structure 313 can replace a flat wall with right corners, that would be located opposite the inlet flat section 314, with an arcuate shape which extends over and includes the first separation wall 33 and fragments of the bottom wall 38 and the top wall 37 adjacent the first inlet channel 311.

Similarly, the outlet arcuate structure 323 can replace a flat wall with right corners, that would be located opposite the outlet flat section 324, with an arcuate shape which extends over and includes the second separation wall 34 and fragments of the bottom wall 38 and the top wall 37 adjacent the first outlet channel 321.

In general, the central arcuate structure 36 is has an arcuate shape in cross-section of the tube 30, in particular in cross-section of the general direction of extension of the tube 30 between the primary tank 10 and the secondary tank 20.

The dividing wall 13 can be in contact with the inlet arcuate structure 313 and the outlet arcuate structure 323.

The dividing wall 13 can be brazed with the inlet arcuate structure 313 and the outlet arcuate structure 323.

The inlet arcuate structure 313 and the outlet arcuate structure 323 can extend over the top wall 37 and the bottom wall 38.

The inlet channel wall 312 and the outlet channel wall 322 can extend between the top wall 37 and the bottom wall 38.

The central arcuate structure 36 can form a circular shape in cross-section of the separation space 35.

The central arcuate structure 36 can extend through the whole tube 30 between the primary tank 10 and the secondary tank 20.

FIG. 7 shows schematically a view of another example of a tube 30 of the tubular element 1. The separation space 35 can have a height smaller than the height of the first inlet channel 311 or the first outlet channel 311 when measured along the inlet channel wall 312 or outlet channel wall 322, respectively.

FIG. 8 shows schematically a view of an example of a tube 30 of the tubular element 1. The separation space 35 can be formed of two separation space portions 351 arranged next to each other with a third separation wall 39 placed between them. Increased concentration of the walls 33, 34 and 39 with arcuate structures 36, 313, 323 can promote capillary action of the filler material and further promote creation of advantageous connection between the elements.

1. A tubular element for a heat exchanger, comprising:
a primary tank with an inlet chamber and an outlet chamber for a heat exchange fluid,
a secondary tank,
a tube extending between the primary tank and the secondary tank, with a set of inlet channels and a set of outlet channels, configured so as to provide U-flow for the fluid within the tubular element,
wherein the primary tank includes a dividing wall between the inlet chamber and the outlet chamber,
wherein the tube includes a first separation wall and a second separation wall with a separation space between the first separation wall and the second separation wall,
the first separation wall and the second separation wall being configured to block fluid flow between the set of inlet channels and the set of outlet channels within the tube,
wherein the dividing wall is in contact with the first separation wall and the second separation wall,
wherein the set of inlet channels includes a first inlet channel limited by the first separation wall and an inlet channel wall, and wherein the set of outlet channels includes a first outlet channel limited by the second separation wall and an outlet channel wall,
wherein the separation space includes a central arcuate structure adjacent the dividing wall.

2. The tubular element according to claim 1, wherein the central arcuate structure extends through the whole tube between the primary tank and the secondary tank.

3. The tubular element according to claim 1, wherein the first inlet channel includes an inlet arcuate structure at the first separation wall, while the first outlet channel includes an outlet arcuate structure at the second separation wall.

4. The tubular element according to claim 3, wherein the inlet arcuate structure and the outlet arcuate structure extend through the whole tube between the primary tank and the secondary tank.

5. The tubular element according to claim 3, wherein the tube includes a top wall and a bottom wall opposite the top wall, with the set of inlet channels and the set of outlet channels being arranged between the top wall and the bottom wall, wherein the inlet arcuate structure and the outlet arcuate structure extend over the top wall and the bottom wall.

6. The tubular element according to claim 1, wherein the first inlet channel includes an inlet flat section at the inlet channel wall, while the first outlet channel includes an outlet flat section at the outlet channel wall.

7. The tubular element according to claim 1, wherein the central arcuate structure forms a circular shape in cross-section of the separation space.

8. The tubular element according to claim 1, wherein the tube includes a top wall and a bottom wall opposite the top wall, with the set of inlet channels and the set of outlet channels being arranged between the top wall and the bottom wall, wherein the separation space has a height smaller than the height of the first inlet channel or the first outlet channel when measured along the inlet channel wall or outlet channel wall, respectively.

9. The tubular element according to claim 1, wherein the separation space is formed of two separation space portions arranged next to each other with a third separation wall placed between them.

10. The tubular element according to claim 1, wherein the tube includes a top wall and a bottom wall opposite the top wall, with the set of inlet channels and the set of outlet channels being arranged between the top wall and the bottom wall, wherein the first separation wall and the second separation wall extend between the top wall and the bottom wall.

11. The tubular element according to claim 1, wherein the tube includes a top wall and a bottom wall opposite the top wall, with the set of inlet channels and the set of outlet channels being arranged between the top wall and the bottom wall, wherein the inlet channel wall and the outlet channel wall extend between the top wall and the bottom wall.

12. The tubular element according to claim 1, wherein the set of inlet channels includes a plurality of second inlet channels of a rectangular shape in cross-section, arranged in series next to each other, while the set of outlet channels includes a plurality of second outlet channels of a rectangular shape in cross-section, arranged in series next to each other.

13. The tubular element according to claim 1, wherein the tube extends along a meandering path between the primary tank and the secondary tank.

14. The tubular element according to claim 1, wherein the primary tank is formed from two shaped portions connected to each other.

15. The tubular element according to claim 14, wherein the two shaped portions are connected to each other by crimping tabs present on at least one of the two shaped portions.

16. The tubular element according to claim 14, wherein each of the two shaped portions includes a dividing wall component extending towards the other of the two shaped portions so that the dividing wall components are connected to each other and together they form the dividing wall.

17. The tubular element according to claim 1, wherein the dividing wall is in contact with the central arcuate structure.

18. The tubular element according to claim 1, wherein the dividing wall is in contact with the inlet arcuate structure and the outlet arcuate structure.

19. The tubular element according to claim 1, wherein the dividing wall is brazed with the inlet arcuate structure and the outlet arcuate structure.

20. A tube for a tubular element of a heat exchanger, comprising:
a set of inlet channels and a set of outlet channels, and
a first separation wall and a second separation wall with a separation space between the first separation wall and the second separation wall,
the first separation wall and the second separation wall being configured to block fluid flow between the set of inlet channels and the set of outlet channels within the tube;
wherein the set of inlet channels includes a first inlet channel limited by the first separation wall and an inlet channel wall, and wherein the set of outlet channels includes a first outlet channel limited by the second separation wall and an outlet channel wall,
wherein the set of inlet channels includes a plurality of second inlet channels of a rectangular shape in cross-section, arranged in series next to each other, while the set of outlet channels includes a plurality of second outlet channels of a rectangular shape in cross-section, arranged in series next to each other,
wherein the separation space includes a central arcuate structure,
wherein the first inlet channel includes an inlet flat section at the inlet channel wall, while the first outlet channel includes an outlet flat section at the outlet channel wall,
wherein the first inlet channel includes an inlet arcuate structure at the first separation wall, while the first outlet channel includes an outlet arcuate structure at the second separation wall.
